(19) United States
(12) Patent Application Publication
(10) Pub. No.: US 2026/0042412 A1
(43) Pub. Date: Feb. 12, 2026

(54) HYDRAULIC SYSTEM AND PASSENGER RESTRAINT SYSTEM

(71) Applicant: HAWE Hydraulik SE, Aschheim (DE)

(72) Inventors: Alexander Ahle, Aschheim (DE); Eike Stratmann, Aschheim (DE); Sergej Bolz, Aschheim (DE); Andre Hermel, Aschheim (DE)

(73) Assignee: HAWE Hydraulik SE, Aschheim (DE)

(21) Appl. No.: 19/292,006

(22) Filed: Aug. 6, 2025

(30) Foreign Application Priority Data
Aug. 7, 2024 (DE) 10 2024 207 504.3

(51) Int. Cl. B60R 21/02; B60R 21/00

(52) U.S. Cl. CPC B60R 21/02; B60R 2021/0097; B60R 2021/0213; B60R 2021/022

(57) ABSTRACT

A hydraulic system for a passenger restraint device includes a hydraulic pump, at least one hydraulic section with a hydraulic accumulator, a valve arrangement and a hydraulic cylinder unit with a piston. The valve arrangement is connected to the hydraulic pump, the hydraulic accumulator and the hydraulic cylinder unit and can be controlled by a higher-level control unit. The hydraulic pump is configured to pressurize the hydraulic cylinder unit by switching the valve arrangement to an opening switching position, so that the piston moves to an open position. The hydraulic accumulator is configured to pressurize the hydraulic cylinder unit by switching the valve arrangement to a closing switching position so that the piston moves to a close position. The higher-level control is connected to a manually operable sensor system and switches the valve arrangement to the closing switching position when the manually operable sensor system is actuated.

### CROSS REFERENCE TO RELATED APPLICATION

This application claims the priority benefit of German Patent Application No. 10 2024 207 504.3, filed on Aug. 7, 2024, the entire contents of which is incorporated herein by reference.

### FIELD

The present disclosure relates to a hydraulic system for a passenger restraint device and to a passenger restraint system comprising at least one passenger restraint device with such a hydraulic system. A passenger restraint device within the meaning of the present disclosure is to be understood as a restraint device for passengers in 4D cinemas, simulators, VR rides and rides such as roller coasters or roundabout rides.

### BACKGROUND

Such passenger restraint devices are used in particular for rides such as roller coasters, simulators or other amusement facilities. In some cases, considerable forces and accelerations act on the passengers in the rides. Passenger restraint devices are therefore provided to hold passengers in place on the passenger seats they occupy. The passenger restraint device regularly has a hydraulically operated restraint bar for retracting and extending it. If the restraint bar is retracted, the passenger restraint device is closed so that the passenger is fixed in the passenger seat. However, if the restraint bar is extended, the passenger restraint device is open so that the passenger can enter and exit the passenger seat.

A hydraulic system is used to open and close the passenger restraint device. For this purpose, such a hydraulic system usually comprises a hydraulic pump, a hydraulic accumulator and a hydraulic cylinder unit with a piston. The piston is movably disposed within the hydraulic cylinder unit in order to adjust the passenger restraint device. To open the passenger restraint device, the piston is pressurized by the hydraulic pump. To close, on the other hand, the piston is pressurized by the hydraulic accumulator.

Corresponding hydraulic systems are known from the prior art, for example from WO 2019/229183 A1, and regularly have fixed, for example lockable, close positions of the restraint bar. However, due to different sizes or body circumferences of the passengers, fixed locking positions can lead to inadequate or excessive restraint of the passengers. This leads to discomfort for passengers.

In addition, it is also time-consuming for a ride employee to visually check the close position of the restraint bar on a ride. Rides can regularly have more than ten individual passenger seats, which means that complex checks result in a reduced frequency of rides. Furthermore, the costs for the inspecting employee are usually not insignificant.

### SUMMARY

The embodiments of a hydraulic system for a passenger restraint device is provided in the present disclosure. In one embodiment, the hydraulic system includes a hydraulic pump, at least one hydraulic section with a hydraulic accumulator, a valve arrangement, and a hydraulic cylinder unit with a piston. The valve arrangement is connected to the hydraulic pump, the hydraulic accumulator and the hydraulic cylinder unit. The valve arrangement can be controlled by a higher-level control unit. The piston is movable between an open position and a close position. The hydraulic pump is configured to pressurize the hydraulic cylinder unit by switching the valve arrangement to an opening switching position, so that the piston moves from the close position to the open position. The hydraulic accumulator is configured to pressurize the hydraulic cylinder unit by switching the valve arrangement into a closing switching position, so that the piston moves from the open position into the close position. The higher-level control unit is connected to a manually operable sensor system and switches the valve arrangement to the closing switching position when the manually operable sensor system is actuated.

In some aspects, the manually operable sensor system comprises a first manual sensor.

In some aspects, the manually operable sensor system comprises a second manual sensor, and the higher-level control unit only switches the valve arrangement to the closing switching position when the first manual sensor and the second manual sensor are actuated simultaneously.

In another aspect, the hydraulic system further comprises a closing range sensor connected to the higher-level control unit, and the closing range sensor is configured to at least indirectly detect a minimum close position of the piston.

In some aspects, the valve arrangement can be switched into at least a first switching position corresponding to the opening switching position and a second switching position, and the hydraulic cylinder unit is pressurized by the hydraulic pump in the first switching position with a first pressure stage and the hydraulic cylinder unit is pressurized by the hydraulic pump in the second switching position with a second pressure stage which is lower than the first pressure stage.

In some aspects, the valve arrangement comprises a first pressure relief valve and a first directional control valve. The first directional control valve blocks a flow path to the first pressure relief valve in the first switching position of the valve arrangement, and opens the flow path to the first pressure relief valve in the second switching position of the valve arrangement, The first pressure relief valve is configured to set the second pressure stage.

In some aspects, the valve arrangement comprises a second directional control valve and a second pressure relief valve. The valve arrangement can be switched to a third switching position corresponding to the closing switching position. The hydraulic cylinder unit is pressurized by the hydraulic pump in the third switching position with a third pressure stage, in that the second directional control valve in the third switching position blocks the flow path to the first pressure relief valve and releases it to the second pressure relief valve. The second pressure relief valve is configured to set the third pressure stage.

In some aspects, the hydraulic accumulator is configured to pressurize the hydraulic cylinder unit with a fourth pressure stage which is lower than the first pressure stage.

In some aspects, the fourth pressure stage of the hydraulic accumulator is lower than the second pressure stage. In some aspects, the third pressure stage is preferably lower than the fourth pressure stage.

In some aspects, the hydraulic cylinder unit is configured as a differential cylinder. The hydraulic cylinder unit has a hydraulic cylinder housing with an interior. The piston is movably disposed in the interior of the hydraulic cylinder housing and separates the interior of the hydraulic cylinder housing into a first working chamber and a second working chamber. The first working chamber is connected to the hydraulic accumulator and the second working chamber is connected to the hydraulic pump.

In some aspect, the valve arrangement comprises a third directional control valve between the hydraulic cylinder unit and the hydraulic accumulator. The third directional control valve is switchable between a through position and a blocking position. The third directional control valve blocks the flow path from the hydraulic cylinder unit to the hydraulic accumulator in the blocking position but releases the flow path from the hydraulic accumulator to the hydraulic cylinder unit in the through position.

In some aspects, the hydraulic section is a first hydraulic section and the hydraulic system comprises at least one second hydraulic section identical to the first hydraulic section. The first hydraulic section is connected to the second hydraulic section in such a way that the piston of the first hydraulic section can be moved independently of a piston of the second hydraulic section. The at least one second hydraulic section is connected to the hydraulic pump.

In some aspects, the hydraulic system comprises a tank and a return channel connecting the at least one hydraulic section to the tank. The hydraulic system comprises a supply channel connecting the hydraulic pump to the at least one hydraulic section. An additional pressure accumulator is connected to the supply channel. In some aspects, a drain valve switchable between a close position and an open position connects the return channel to the supply channel.

Also provided is a passenger restraint system with at least one passenger restraint device and a hydraulic system according to the embodiments of the present disclosure, where the passenger restraint system comprises a seat and the manually operable sensor system is disposed on the seat.

A method for closing a restraint bar of a passenger restraint device with a hydraulic system according to the embodiments of the present disclosure is also provided. In one aspect, the method comprising the following steps:
a. actuating a manually operable sensor system by a passenger accommodated in a passenger seat of the passenger restraint device;
b. generating a closing signal by actuating the manually operable sensor system;
c. receiving of the closing signal by a higher-level control unit; and
d. switching of a valve arrangement of the hydraulic system to a closing switching position by the higher-level control unit.

### BRIEF DESCRIPTION OF THE DRAWINGS

FIG. 1 depicts a hydraulic circuit diagram of a hydraulic system according to the present disclosure;

FIG. 2 depicts a passenger restraint system with a passenger restraint device and the hydraulic system;

FIG. 3 depicts a first view of a passenger restraint system with a seat according to FIG. 2; and

FIG. 4 depicts a second view of the passenger restraint system shown in FIG. 3.

### DETAILED DESCRIPTION

It is the object of the present disclosure to provide an improved hydraulic system which increases the degree of automation of a passenger restraint system and at the same time reduces the effort of control.

The problem is solved with a hydraulic system and a passenger restraint system according to embodiments disclosed herein.

The hydraulic system according to the disclosure for a passenger restraint device comprises a hydraulic pump and a hydraulic section. The hydraulic section comprises a hydraulic accumulator, a valve arrangement and a hydraulic cylinder unit with a piston. The valve arrangement is connected to the hydraulic pump, the hydraulic accumulator and the hydraulic cylinder unit. Furthermore, the valve arrangement can be controlled by a higher-level control unit. The piston can be moved between an open position and a close position. The hydraulic pump is configured to pressurize the hydraulic cylinder unit by switching the valve arrangement into an opening switching position so that the piston moves from the close position to the open position. The hydraulic accumulator is configured to pressurize the hydraulic cylinder unit by switching the valve arrangement into a closing switching position so that the piston moves from the open position to the close position. The higher-level control unit is connected to a manually operable sensor system. The higher-level control unit switches the valve arrangement to the closing switching position when the manually operable sensor system is actuated.

The hydraulic system may comprise the higher-level control unit and/or the manually operable sensors. However, it is also conceivable that the passenger restraint device comprises the higher-level control unit and/or the manually operable sensor system. In this case, the hydraulic system is configured to receive the control signals from the higher-level control unit and switch the valve arrangement accordingly. It is also conceivable that the hydraulic system comprises the higher-level control unit, which communicates with another control unit, for example of the passenger restraint device or of the ride.

In other words, the hydraulic pump opens a restraint bar of the passenger restraint system and the hydraulic accumulator closes the restraint bar to the close position. The open position of the piston corresponds to the open position of the passenger restraint so that a passenger can get on and off. The close position of the piston corresponds to the position of the passenger restraint in which the passenger is securely fixed.

This provides a simple and highly automated hydraulic system.

The hydraulic accumulator has the advantage that the hydraulic pump does not have to be in operation for the opening process. On the one hand, this reduces noise and, on the other hand, a smaller hydraulic pump can be used.

In some aspects, the manually operable sensor system comprises a first manual sensor. In some aspects, the manually operable sensor system comprises a second manual sensor. The higher-level control unit preferably only switches the valve arrangement to the closing switching position when the first manual sensor and the second manual sensor are actuated simultaneously or in parallel by the passenger. This ensures that the passenger does not have their hands in the closing area of the restraint bar when the restraint bar is closed. For the purposes of the present disclosure, a manual sensor is to be understood as a means which detects the spatially close presence of a body part or contact by a body part. A manual sensor in the sense of the present disclosure can therefore be, for example, a button, a resetting switch or a capacitive manual sensor.

In some aspects, the hydraulic system comprises a closing range sensor connected to the higher-level control unit, whereby the closing range sensor is configured to at least indirectly detect a minimum close position of the piston. This can be done, for example, by monitoring the piston position or by monitoring the restraint bar position. Only when this minimum close position is reached or exceeded, a release signal is generated by the higher-level control unit, which enables the ride to depart or similar.

The valve arrangement can preferably be switched to at least a first switching position corresponding to the opened switching position. In some aspects, the valve arrangement can be switched to a second switching position. The hydraulic cylinder unit is pressurized by the hydraulic pump in the first switching position, preferably with a first pressure stage. The hydraulic cylinder unit is pressurized by the hydraulic pump in the second switching position, preferably with a second pressure stage, whereby the second pressure stage is lower than the first pressure stage.

This allows the valve arrangement to switch between the switching positions in two pressure stages, so that the hydraulic cylinder unit is subjected to a high pressure when the restraint bar is opened.

This allows the restraint bar to be adjusted manually by the passenger in an advantageous manner when the hydraulic cylinder unit is pressurized with the second pressure stage. If, on the other hand, the hydraulic cylinder unit is pressurized with the first pressure stage, the restraint bar cannot be adjusted by the passenger. By manually adjusting the restraint bar in the second switching position, the passenger can adjust the position of the restraint bar according to their size and/or body circumference, so that the passenger is firmly and securely held in place by the passenger restraint device.

Furthermore, the hydraulic accumulator can preferably be operated at a lower pressure than the pressure of the hydraulic pump, which is required to close the restraint bar. Because the hydraulic cylinder unit is subjected to the higher pressure of the hydraulic pump when the restraint bar is opened, hydraulic fluid is fed back into the hydraulic accumulator when the piston is moved into the open position. This recharges the hydraulic accumulator so that the full accumulator pressure is available for closing the restraint bar.

The hydraulic pump is preferably configured as a fixed displacement pump, i.e. the delivery rate of the pump is constant and is not regulated. The manufacturing costs of the hydraulic system can be reduced compared to an adjustable variable displacement pump, whose delivery rate can be varied. A safety pressure relief valve is provided between the hydraulic pump and the hydraulic cylinder unit to prevent overpressure or damaging pressure peaks in the hydraulic system.

In some aspects, the valve arrangement comprises a first pressure relief valve and a first directional control valve, wherein the first directional control valve blocks a flow path to the first pressure relief valve in the first switching position of the valve arrangement, and wherein the first directional control valve opens the flow path to the first pressure relief valve in the second switching position of the valve arrangement, wherein the first pressure relief valve is configured to set the second pressure stage. The second pressure stage can be preferably set by the first pressure relief valve so that it is lower than the first pressure stage. The first directional control valve preferably enables the flow path to the first pressure relief valve to be blocked when the restraint bar is opened, so that the hydraulic cylinder unit is subjected to the first pressure stage by the hydraulic pump. This prevents hydraulic fluid from flowing out via the first pressure relief valve. When the piston is in the open position, the restraint bar can thus preferably serve as a handle for passengers to get on and off, as it is held in place by the relatively high pressure in the first pressure stage.

In addition, the valve arrangement preferably comprises a second directional control valve and a second pressure relief valve, whereby the valve arrangement can be switched to a third switching position corresponding to the closing switching position. The hydraulic cylinder unit is pressurized by the hydraulic pump in the third switching position with a third pressure stage, in that the second directional control valve blocks the flow path to the first pressure relief valve in the third switching position of the valve arrangement and releases it to the second pressure relief valve, whereby the second pressure relief valve is configured to set the third pressure stage. This makes it possible to switch between the second and third pressure stages when closing the restraint bar. In the third pressure stage, the hydraulic system moves the piston from the open position to a preferably predetermined close position with the aid of the hydraulic accumulator. The predetermined close position can, for example, be the minimum close position.

In some aspects, the hydraulic accumulator is configured to pressurize the hydraulic cylinder unit with a fourth pressure stage, whereby the fourth pressure stage is lower than the first pressure stage. In other words, the operating pressure of the hydraulic accumulator is lower than the operating pressure of the hydraulic pump. As a result, the hydraulic accumulator is advantageously charged by the fluid displaced from the hydraulic cylinder unit when the piston is moved from the close position to the open position.

In addition, the fourth pressure stage of the hydraulic accumulator may be lower than the second pressure stage. Thereby, the pressure difference between the fourth and second pressure stages is so small that the pressure difference can be overcome by the passenger. The passenger pulls the restraint bar towards him and exerts additional pressure on the hydraulic cylinder unit to the already applied fourth pressure stage and against the second pressure stage. The additional pressure and the fourth pressure stage together exceed the second pressure stage set on the first pressure relief valve, so that manual closing is possible.

When the predetermined close position is reached, the valve arrangement can switch to the second switching position and thus the second pressure stage is applied so that the restraint bar of the passenger restraint device can now be adjusted manually. This further increases the degree of automation in an preferable way and enables an improved position of the restraint bar for securely restraining the passenger.

In some aspects, the piston can be moved manually from the predetermined close position to a second close position, with the predetermined close position lying between the open position and the second close position. The second close position of the piston is variable and corresponds to the position of the passenger restraint device, in which the passenger is securely fixed according to his or her body circumference. In a preferable manner, the restraint bar moves automatically from the open position to the predetermined close position, so that the passenger can pull the restraint bar towards him manually until the restraint bar securely fixes the passenger.

However, it is also conceivable that the valve arrangement remains in the third switching position and the passenger closes the restraint bar to a position that is comfortable for the passenger by actuating the manually operable sensor system. In particular, the passenger actuates the manually operable sensor system until the restraint bar “hits” the passenger and no longer moves due to the greater back pressure.

In some aspects, the fourth pressure stage is higher than the third pressure stage. The pressure difference between the fourth pressure stage and the third pressure stage is so small that the closing movement of the restraint bar can be adjusted via the third pressure stage.

In some aspects, the hydraulic cylinder unit is configured as a differential cylinder, and the hydraulic cylinder unit has a hydraulic cylinder housing with an interior, whereby the piston is movably disposed in the interior of the hydraulic cylinder housing. The piston separates the interior of the hydraulic cylinder housing into a first working chamber and a second working chamber, whereby the first working chamber is connected to the hydraulic accumulator and the second working chamber is connected to the hydraulic pump. As a rule, the differential cylinder has a piston rod on one side of the piston surface. As a result, the entire piston surface acts on one side of the piston and only the ring surface acts on the rod-side surface. The differential cylinder therefore has two active surfaces of different sizes. In the present case, the rod-side surface faces the first working chamber and the entire piston surface faces the second working chamber. The differential cylinder configuration allows the hydraulic cylinder unit to be more compact.

In some aspects, the valve arrangement comprises a third directional control valve between the hydraulic cylinder unit and the hydraulic accumulator, wherein the third directional control valve can be switched between a through position and a blocking position, wherein the third directional control valve blocks the flow path from the hydraulic cylinder unit to the hydraulic accumulator in the blocking position, but opens the flow path from the hydraulic accumulator to the hydraulic cylinder unit in the through position. In a preferable manner, the third directional control valve is switched to the through position when the restraint bar is opened and switched to the blocking position when it is closed. When the restraint bar is in its final close position, in which the passenger is fixed, the fluid is locked in the hydraulic device. This means that the restraint bar cannot open during the journey.

In some aspects, the valve arrangement switches to the third switching position when the piston moves from the open position to the close position or to the predetermined close position. As a result, the pressure of the hydraulic accumulator is greater than the third pressure stage, which is set by the second pressure relief valve, and the hydraulic system preferable moves the piston automatically from the open position to the first close position.

In some aspects, the valve arrangement switches to the second switching position when the piston moves from the predetermined close position to the final close position. As a result, the pressure of the hydraulic accumulator is lower than the second pressure level, which is set by the first pressure relief valve, so that the piston can only be moved into the second close position with additional manually applied pressure.

In some aspects, the predetermined close position of the piston is adjustable. This allows the predetermined close position of the restraint bar to be adapted in a preferable way, for example to country-specific body characteristics or for children's rides. The rides can also differ in terms of the loads, forces or acceleration values, so that a tighter fixation of the passengers may be necessary.

In some aspects, the hydraulic section is a first hydraulic section and the hydraulic system comprises at least one second hydraulic section identical to the first hydraulic section. In some aspects, the first hydraulic section is connected to the second hydraulic section in such a way that the piston of the first hydraulic section can be moved independently of a piston of the second hydraulic section, with the at least one second hydraulic section being connected to the hydraulic pump. This allows several passenger restraint devices to be preferably operated with just one hydraulic pump. Ideally, all passenger restraint devices in a ride are operated with just one hydraulic pump. This results in lower manufacturing and installation costs. To prevent mutual interference between the individual hydraulic sections, each hydraulic section is fitted with a non-return valve. This allows, for example, the restraint bars to be closed independently of each other.

In some aspects, the hydraulic system comprises a tank so that hydraulic fluid flowing back from the hydraulic cylinder unit or hydraulic fluid flowing out via the pressure relief valves flows back into the tank. In some aspects, the hydraulic system has a return channel connecting the at least one hydraulic valve section to the tank for this purpose. Preferably, the hydraulic system has a supply channel connecting the at least one valve section to the hydraulic pump.

In some aspects, an additional pressure accumulator is connected to the supply channel. This is particularly preferable when using less powerful hydraulic pumps.

In some aspects, a drain valve that can be switched between a closed position and an open position connects the return channel to the supply channel. By switching the drain valve, the supply channel can be relieved directly into the return channel so that the restraint bar can be closed more quickly.

In some aspects, the third directional control valve can be operated electrically and manually. In a ride with several carriages, for example a roller coaster, the carriages are usually only supplied with power in the station, for example via a current collector. When leaving the station, the carriage is de-energized so that the third directional control valve cannot be actuated electrically. If the carriage comes to a standstill on the open track or in the event of a power failure, the restraint bar can be opened by manually actuating the third directional control valve so that the passengers can leave the carriage and the ride.

In some aspects, the hydraulic system comprises a non-return valve between the hydraulic cylinder unit and the hydraulic pump, which blocks the flow path from the hydraulic cylinder unit to the hydraulic pump. In combination with the blocked first directional control valve, the hydraulic fluid is locked in the hydraulic cylinder unit when the piston is in the open position. This means that the restraint bar of the passenger restraint device can be used as an entry and/or exit aid for the passenger to hold onto.

A passenger restraint system according to the present disclosure comprises at least one passenger restraint device and a hydraulic system as described above. The passenger restraint system can comprise several passenger restraint devices which can be actuated via a hydraulic system, whereby each passenger restraint device is then assigned a hydraulic section.

In some aspects, the passenger restraint system comprises a seat, with the manually operable sensor system being disposed on the seat. Preferably, the first manual sensor is disposed on a first side of the seat and the second manual sensor is disposed on a second side opposite the first side. Preferably, the manual sensors point in opposite directions. This ensures that a passenger does not have their hands in the area of movement of the restraint bar during the closing process.

Furthermore, the present disclosure relates to a method for closing a restraint bar of a passenger restraint device with a hydraulic system described above. The method comprises the following steps:
actuating a manually operable sensor system by a passenger accommodated in a passenger restraint device;
generating a closing signal by actuating the manually operable sensor system;
receiving of the closing signal by a higher-level control unit; and
switching a valve arrangement of the hydraulic system to a closing switching position by the higher-level control unit.

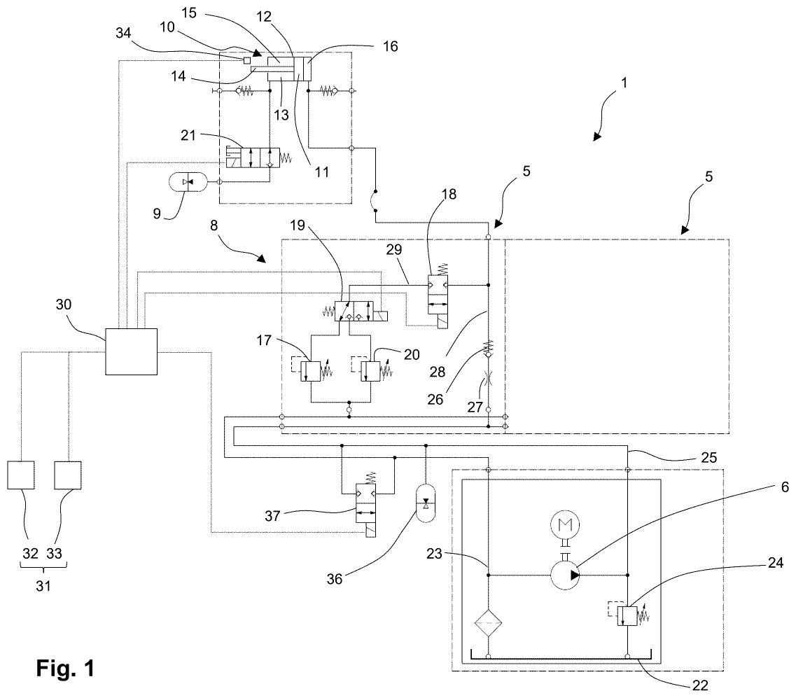

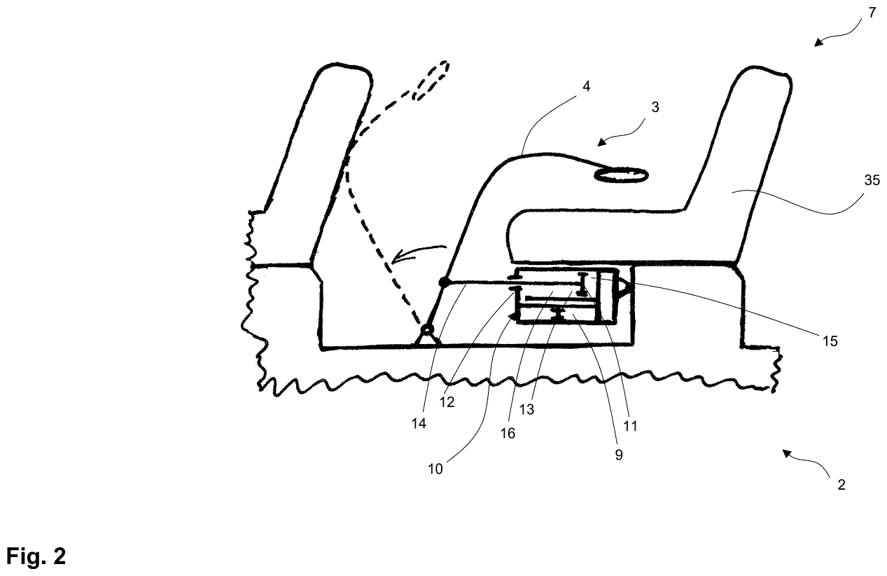

FIG. 1 shows a hydraulic circuit diagram of a hydraulic system 1 for a passenger restraint device according to the present disclosure. FIG. 2 shows a passenger restraint system 2 with the passenger restraint device 3, which comprises a restraint bar 4 to fix a passenger in a passenger seat 7 occupied by the passenger.

The hydraulic system 1 comprises a hydraulic pump 6, which is configured as a fixed displacement pump with a constant delivery rate. The hydraulic pump 6 can also be configured as a controlled variable displacement pump with a variable delivery rate. The hydraulic system 1 comprises at least one hydraulic section 5. In this exemplary embodiment, only one hydraulic section 5 is shown in full, but two or more hydraulic sections 5 can also be provided, as indicated by the dashed boxes shown. Each hydraulic section 5 comprises a valve arrangement 8 connected to a higher-level control unit 30, a hydraulic accumulator 9 and a hydraulic cylinder unit 10 with a piston 11.

As can also be seen in FIG. 1, the hydraulic system 1 comprises a tank 22 and a return channel 23 connected to the tank 22. Hydraulic fluid return flowing from the second working chamber 16 of the hydraulic cylinder unit 10 flows back into the tank 22 via the return channel 23, as will be described in more detail below.

The hydraulic sections 5 of the hydraulic system 1 are connected to the hydraulic pump 6 via a supply channel 25 and to the tank 22 via the return channel 23.

The hydraulic cylinder unit 10 comprises a hydraulic cylinder housing 12 with an interior 13 in which the piston 11 is movable. The piston 11 has a piston rod 14, which is connected to the restraint bar 4 of the passenger restraint device 3 in order to open and close the passenger restraint device 3. The hydraulic cylinder unit 10 is configured as a differential cylinder. The piston 11 divides the interior 13 into a first working chamber 15 and a second working chamber 16. The first working chamber 15 is connected to the hydraulic accumulator 9 and the second working chamber 16 is connected to the hydraulic pump 6.

The hydraulic pump 6 is configured to pressurize the second working chamber 16 of the hydraulic cylinder unit 10 in order to move the piston 11 from a close position to an open position. For this purpose, the valve arrangement 8 is switched to an opened switching position by the higher-level control unit 30, as will be described in more detail below. As shown, the second working chamber 16 is connected to the hydraulic pump 6 via a pressure line 28 branching off from the supply channel 25. As shown, a non-return valve 26 and an adjustable throttle valve 27 can be disposed in the pressure line 28 in order, on the one hand, to regulate the inflowing quantity and, on the other hand, to prevent a return flow to the hydraulic pump 6. This prevents interactions between the hydraulic cylinder units 10 of the respective hydraulic section 5. Due to the different lengths of the line between the hydraulic pump 6 and the respective hydraulic cylinder unit 10, pressure losses can occur along the supply channel 25. In order to apply the same pressure to all hydraulic cylinder units 10, the individual hydraulic sections 5 are hydraulically balanced with each other via the adjustable throttle valve 27.

The hydraulic accumulator 9, on the other hand, is configured to pressurize the first working chamber 15 of the hydraulic cylinder unit 10 in order to move the piston 11 from the open position to the first close position. For this purpose, the valve arrangement 8 is switched to a closing switching position via the higher-level control unit 30, as will be described in more detail below. The open position of the piston 11 corresponds to the position of the extended restraint bar 4 and the passenger restraint device 3 is open so that the passenger can enter and exit the passenger seat 7. The first close position of the piston 11 corresponds to the position of the retracted restraint bar 4 to the extent that the passenger restraint device 3 is closed up to the largest conceivable body circumference of the passenger. In the open position, the piston 11 is fixed due to the relatively high pressure and can then also be used by the passenger as a handhold.

In addition, the piston 11 can be moved into a second close position via a manually operable sensor system 31. The first close position lies between the open position and the second close position. The second close position of the piston 11 is variable and corresponds to the position of the passenger restraint device 3, in which the passenger is securely fixed according to his or her body circumference. To move the piston 11 into the second close position, the passenger actuates the manually operable sensor system 31 and the restraint bar 4 moves closer until the body pressure prevents any further movement of the restraint bar 4. As only very low pressures prevail here, an excessive closing movement, which could be uncomfortable for the passenger, is ruled out.

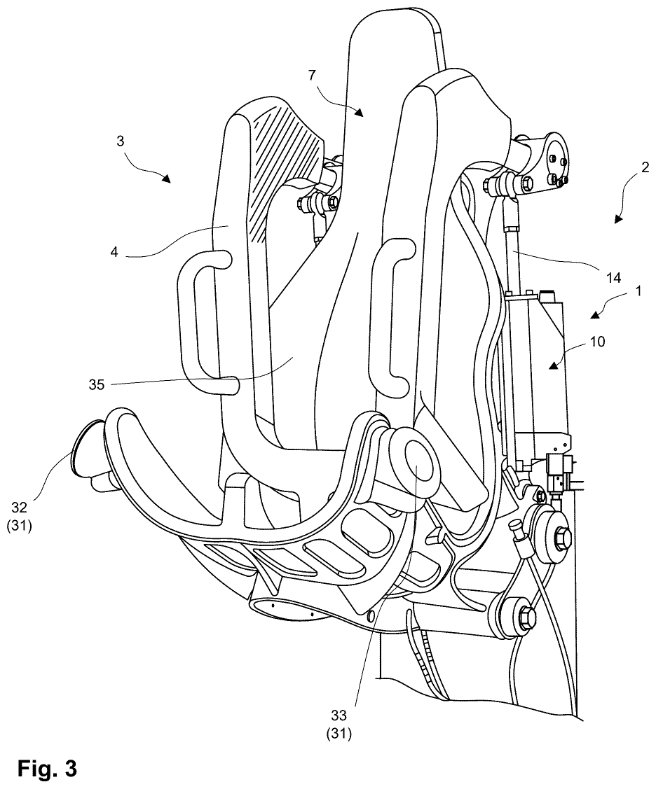

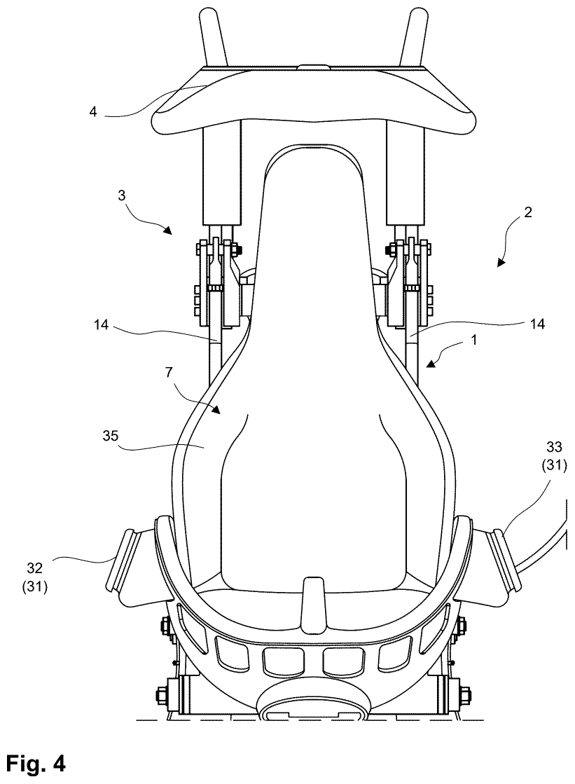

In some embodiments, the manually operable sensor system 31 comprises a first manual sensor 32 and a second manual sensor 33. As shown in FIGS. 3 and 4, the first manual sensor 32 and the second manual sensor 33 are each disposed on the side of the passenger seat 7 or on a seat 35 of the passenger seat 7. In particular, the passenger actuates both the first manual sensor 32 and the second manual sensor 33 in parallel so that the valve arrangement 8 switches to the closing switching position via the higher-level control unit 30 and the restraint bar 4 is closed. This ensures that the passenger's hands are not in the movement range of the restraint bar 4 during the closing movement. In the exemplary embodiment shown in FIGS. 3 and 4, the hydraulic system 1 comprises two hydraulic cylinder units 10 that move the restraint bar 4. It is understood that the hydraulic system 1 can also be configured with only one or with more than two hydraulic cylinder units 10, depending on the requirements. For the sake of completeness, it should be noted that the restraint bar 4 is shown fully closed in FIG. 3 (i.e. the piston 11 is in the close position) and fully open in FIG. 4 (i.e. the piston 11 is in the open position).

In addition, the hydraulic system comprises a closing range sensor 34 connected to the higher-level control unit 30. The closing range sensor 34 is configured to at least indirectly detect a minimum close position of the piston 11. Only when the closing range sensor 34 detects that the piston 11 or the restraint bar 4 has reached or exceeded the minimum close position, a corresponding release signal is generated via the higher-level control unit 30. This ensures that a restraint bar 4 that has not been fully or correctly closed by a passenger is detected. This can happen, for example, if the passenger removes their hands from the first manual sensor 32 and/or the second manual sensor 33 before the minimum close position has been reached.

The exact configuration of the valve arrangement 8, the corresponding switching positions and the resulting movements of the restraint bar 4 are described below.

As mentioned above, the valve arrangement 8 can be switched to an opening switching position and a closing switching position via the higher-level control unit 30.

For this purpose, the valve arrangement 8 comprises a first pressure relief valve 17, a first directional control valve 18, a second directional control valve 19, a second pressure relief valve 20 and a third directional control valve 21. The first directional control valve 18 and the second directional control valve 19 are disposed in a branch line 29, which branches off between the second working chamber 16 of the hydraulic cylinder unit 10 and the hydraulic pump 6 and is connected to the return channel 23. The first directional control valve 18 is connected to the pressure line 28 and the second directional control valve 19. The second directional control valve 19 is disposed downstream of the first directional control valve 18 and connects the first directional control valve 18 to the return channel 23 either via the first pressure relief valve 17 or via the second pressure relief valve 20 disposed parallel thereto. The third directional control valve 21 is disposed between the first working chamber 15 of the hydraulic cylinder unit 10 and the hydraulic accumulator 9.

In the first switching position of the valve arrangement 8, the first directional control valve 18 blocks a flow path from the pressure line 28 to the first pressure relief valve 17 and the hydraulic cylinder unit 10 is pressurized by the hydraulic pump 6 at a first pressure stage. This causes the piston 11 to move into the open position and the restraint bar 4 opens. This corresponds to the opening switching position of the valve arrangement 8.

In the second switching position of the valve arrangement 8, the first directional control valve 18 opens the flow path through the branch line 29 and the second directional control valve 19 connects the first directional control valve 18 to the first pressure relief valve 17, so that the hydraulic cylinder unit 10 is pressurized by the hydraulic pump 6 with a second pressure stage. The first pressure relief valve 17 is configured to set the second pressure stage. The pressure stages are selected so that the first pressure stage of the hydraulic pump 6 is higher than the second pressure stage of the first pressure relief valve 17. For example, the first pressure stage can be 100 bar and the second pressure stage 60 bar.

In the third switching position of the valve arrangement 8, the second directional control valve 19 connects the first directional control valve 18 to the second pressure relief valve 20. In this switching position, the hydraulic cylinder unit 10 is pressurized by the hydraulic pump 6 with a third pressure stage. The second pressure relief valve 20 is configured to set the third pressure stage, which is lower than the second pressure stage. The third pressure stage can be 20 bar, for example. The valve arrangement 8 can therefore switch between two different pressure stages when closing the passenger restraint device 3.

The third directional control valve 21 can be switched between a through position and a blocked position. In the through position, the flow path between the first working chamber 15 and the hydraulic accumulator 9 is open in both directions. In the blocked position, on the other hand, the flow path from the first working chamber 15 to the hydraulic accumulator 9 is blocked, but the flow path from the hydraulic accumulator 9 to the first working chamber 15 is enabled.

The hydraulic accumulator 9 is configured to pressurize the hydraulic cylinder unit 10 with a fourth pressure stage. The fourth pressure stage is lower than the first pressure stage and the second pressure stage, but higher than the third pressure stage. The fourth pressure stage can be 40 bar, for example. When the valve arrangement 8 is in the first switching position and the hydraulic pump 6 pressurizes the hydraulic cylinder unit 10 with the first pressure stage so that the piston 11 moves towards the open position, the third directional control valve 21 is switched to the through position so that the hydraulic fluid flows back into the hydraulic accumulator 9. This charges the hydraulic accumulator 9 in order to move the piston 11 from the open position back to the first close position. In other words, in the first switching position of the valve arrangement 8, the third directional control valve 21 is switched into a through switching position via the higher-level control unit 30.

If the piston 11 is in the open position, the valve arrangement 8 is switched to the first switching position so that the first directional control valve 18 blocks the branch line 29. As a result, the hydraulic cylinder unit 10 is pressurized with the first pressure stage. Since the fourth pressure stage of the hydraulic accumulator 9 is considerably lower than the first pressure stage of the hydraulic pump 6, the passenger can support or hold on to the restraint bar 4 of the passenger restraint device 3 and thus use it as an entry and exit aid. The first pressure stage and fourth pressure stage are selected so that the sum of the fourth pressure stage and the additional pressure that the passenger exerts on the restraint bar 4 and thus on the piston 11 when getting in and out is less than the first pressure stage. As a result, the restraint bar 4 cannot be moved by the passenger against the first pressure stage.

In order to move the piston 11 from the open position to the close position, the valve arrangement 8 is switched to the third switching position by the higher-level control unit 30, which corresponds to the closing switching position. In this switching position, the fourth pressure stage is present in the first working chamber 15 of the hydraulic cylinder unit and the third pressure stage is present in the second working chamber 16 of the hydraulic cylinder unit 10. This enables a controlled or specifically set closing movement of the restraint bar 4.

Two operating modes of the hydraulic system 1 or the passenger restraint system 2 are therefore conceivable. In a first operating mode, the restraint bar 4 is closed by the passenger via parallel actuation of the first manual sensor 32 and the second manual sensor 33 until a position of the restraint bar 4 desired and comfortable by the passenger is reached. This position of the restraint bar 4 is achieved in particular when the restraint bar 4 “hits” the passenger and does not move any further in the closing direction due to the greater counterpressure. For this purpose, the valve arrangement 8 is switched to the third switching position. Alternatively, in a second operating mode, the restraint bar 4 can be closed by the passenger via parallel actuation of the first manual sensor 32 and the second manual sensor 33 up to a predetermined position, for example the minimum close position. Once this predetermined position has been reached, the valve arrangement 8 is switched to the fourth switching position via the higher-level control unit 30.

As the second pressure stage is only slightly higher than the fourth pressure stage of the hydraulic accumulator 9, the passenger can then exert sufficient pressure on the piston 11 by pulling the restraint bar 4 so that the sum of the fourth pressure stage and the pressure exerted by the passenger is greater than the second pressure stage set by the first pressure relief valve 17. This means that the piston 11 can be manually adjusted to a convenient and desired close position.

As shown, the third directional control valve 21 can also be actuated manually in order to open the restraint bar 4 manually in the event of a power failure. The first, second and third directional control valves 18, 19, 21 each have return springs that preload the respective directional control valve into a position when the respective directional control valve is not electrically actuated and is therefore de-energized. The first directional control valve 18 is preloaded in such a way that the branch line 29 is blocked. The third directional control valve 21 is preloaded into the blocking position described above, so that further closing of the restraint bar 4 is possible, but opening of the restraint bar 4 is prevented.

The hydraulic system 1 also comprises a third pressure relief valve 24, which connects the supply channel 25 to the tank 22. The third pressure relief valve 24 is configured to set the first pressure stage and prevent pressure peaks in order to prevent damage to the hydraulic system 1. The first pressure stage can be 100 bar, for example.

As shown, the hydraulic system 1 in this exemplary embodiment comprises an additional pressure accumulator 36 and a drain valve 37 that can be controlled by the higher-level control unit 30. The additional pressure accumulator 36 is connected to the supply channel 25 and the drain valve 37 connects the return channel 23 to the supply channel 25. As shown, the drain valve 37 is preloaded into a close position via a corresponding spring, in which the connection between the return channel 23 and the supply channel 25 is blocked. When the drain valve 37 is activated by the higher-level control unit 30, the drain valve 37 is opened and switched to an open position in which the return channel 23 is connected to the supply channel 25.

By switching the drain valve 37, the return channel 23 can be short-circuited with the supply channel 25, so that a faster closing movement of the restraint bar 4 can be achieved, as the volume flow is discharged directly to the tank 22 and not via the valve arrangement 8. On the other hand, the additional pressure accumulator 36 supports the hydraulic pump 6 during an opening movement. The additional pressure accumulator 36 is therefore particularly preferable when using a less powerful hydraulic pump 6.

Although the terms “first”, “second”, “third” and “fourth” are used in this document to distinguish different components, these components are not intended to be limited by these terms. These terms are only used to distinguish the components from each other and no specific order is specified. Thus, for example, a first component described above could be referred to as a second component and vice versa.

1. A hydraulic system for a passenger restraint device, the hydraulic system comprising:
a hydraulic pump;
at least one hydraulic section with a hydraulic accumulator;
a valve arrangement; and
a hydraulic cylinder unit with a piston,
wherein the valve arrangement is connected to the hydraulic pump, the hydraulic accumulator and the hydraulic cylinder unit,
wherein the valve arrangement can be controlled by a higher-level control unit,
wherein the piston is movable between an open position and a close position,
wherein the hydraulic pump is configured to pressurize the hydraulic cylinder unit by switching the valve arrangement to an opening switching position, so that the piston moves from the close position to the open position,
wherein the hydraulic accumulator is configured to pressurize the hydraulic cylinder unit by switching the valve arrangement into a closing switching position, so that the piston moves from the open position into the close position,
wherein the higher-level control unit is connected to a manually operable sensor system, and
wherein the higher-level control unit switches the valve arrangement to the closing switching position when the manually operable sensor system is actuated.

2. The hydraulic system according to claim 1, wherein the manually operable sensor system comprises a first manual sensor.

3. The hydraulic system according to claim 2, wherein the manually operable sensor system comprises a second manual sensor, wherein the higher-level control unit only switches the valve arrangement to the closing switching position when the first manual sensor and the second manual sensor are actuated simultaneously.

4. The hydraulic system according to claim 1, further comprising a closing range sensor connected to the higher-level control unit, wherein the closing range sensor is configured to at least indirectly detect a minimum close position of the piston.

5. The hydraulic system according to claim 1, wherein the valve arrangement can be switched into at least a first switching position corresponding to the opening switching position and a second switching position, wherein the hydraulic cylinder unit is pressurized by the hydraulic pump in the first switching position with a first pressure stage and wherein the hydraulic cylinder unit is pressurized by the hydraulic pump in the second switching position with a second pressure stage, wherein the second pressure stage is lower than the first pressure stage.

6. The hydraulic system according to claim 5, wherein the valve arrangement comprises a first pressure relief valve and a first directional control valve, the first directional control valve blocking a flow path to the first pressure relief valve in the first switching position of the valve arrangement, and wherein the first directional control valve opens the flow path to the first pressure relief valve in the second switching position of the valve arrangement, wherein the first pressure relief valve is configured to set the second pressure stage.

7. The hydraulic system according to claim 6, wherein the valve arrangement comprises a second directional control valve and a second pressure relief valve, wherein the valve arrangement can be switched to a third switching position corresponding to the closing switching position, wherein the hydraulic cylinder unit is pressurized by the hydraulic pump in the third switching position with a third pressure stage, in that the second directional control valve in the third switching position blocks the flow path to the first pressure relief valve and releases it to the second pressure relief valve, wherein the second pressure relief valve is configured to set the third pressure stage.

8. The hydraulic system according to claim 7, wherein the hydraulic accumulator is configured to pressurize the hydraulic cylinder unit with a fourth pressure stage, the fourth pressure stage being lower than the first pressure stage.

9. The hydraulic system according to claim 8, wherein the fourth pressure stage of the hydraulic accumulator is lower than the second pressure stage, and wherein the third pressure stage is preferably lower than the fourth pressure stage.

10. The hydraulic system according to claim 1, wherein the hydraulic cylinder unit is configured as a differential cylinder, and the hydraulic cylinder unit has a hydraulic cylinder housing with an interior, the piston being movably disposed in the interior of the hydraulic cylinder housing, and the piston separates the interior of the hydraulic cylinder housing into a first working chamber and a second working chamber, wherein the first working chamber is connected to the hydraulic accumulator and the second working chamber is connected to the hydraulic pump.

11. The hydraulic system according to claim 1, wherein the valve arrangement comprises a third directional control valve between the hydraulic cylinder unit and the hydraulic accumulator, the third directional control valve being switchable between a through position and a blocking position, wherein the third directional control valve blocks a flow path from the hydraulic cylinder unit to the hydraulic accumulator in the blocking position, but releases the flow path from the hydraulic accumulator to the hydraulic cylinder unit in the through position.

12. The hydraulic system according to claim 1, wherein the hydraulic section is a first hydraulic section and the hydraulic system comprises at least one second hydraulic section identical to the first hydraulic section, the first hydraulic section being connected to the second hydraulic section in such a way that the piston of the first hydraulic section can be moved independently of a piston of the second hydraulic section, the at least one second hydraulic section being connected to the hydraulic pump.

13. The hydraulic system according to claim 1, wherein the hydraulic system comprises a tank and a return channel connecting the at least one hydraulic section to the tank,
wherein the hydraulic system comprises a supply channel connecting the hydraulic pump to the at least one hydraulic section,
wherein an additional pressure accumulator is connected to the supply channel, and/or
wherein a drain valve switchable between a close position and an open position connects the return channel to the supply channel.

14. A passenger restraint system with at least one passenger restraint device and the hydraulic system according to claim 1, wherein the passenger restraint system comprises a seat, wherein the manually operable sensor system is disposed on the seat.

15. A method for closing a restraint bar of a passenger restraint device with the hydraulic system according to claim 1, the method comprising the following steps:
actuating the manually operable sensor system by a passenger accommodated in a passenger seat of the passenger restraint device;
generating a closing signal by actuating the manually operable sensor system;
receiving of the closing signal by a higher-level control unit; and
switching of a valve arrangement of the hydraulic system to a closing switching position by the higher-level control unit.
